(19) United States
(12) Patent Application Publication
(10) Pub. No.: US 2016/0011612 A1
(43) Pub. Date: Jan. 14, 2016

(54) DC-DC CONVERTER AND ORGANIC LIGHT EMITTING DISPLAY DEVICE INCLUDING THE SAME

(71) Applicant: SAMSUNG DISPLAY CO., LTD., Yongin-City (KR)

(72) Inventor: Sung-Chun Park, Yongin-City (KR)

(21) Appl. No.: 14/695,027

(22) Filed: Apr. 23, 2015

(30) Foreign Application Priority Data
Jul. 11, 2014 (KR) 10-2014-0087515

(51) Int. Cl. G05F 1/575; G09G 3/32

(52) U.S. Cl. CPC G05F 1/575; G09G 3/3233

(57) ABSTRACT

A DC-DC converter includes: a converter configured to convert a voltage input to an input terminal into a first voltage, and to output the first voltage to an output terminal; a controller configured to receive a feedback voltage and a reference voltage, and to control the converter; a first auxiliary voltage generator configured to receive a first input voltage and a second input voltage, and to generate a plurality of first auxiliary voltages; a first selector configured to select an initial voltage and a target voltage from the first auxiliary voltages; a second auxiliary voltage generator configured to receive the initial voltage and the target voltage, and to generate a plurality of second auxiliary voltages; and a second selector configured to select any one voltage from the initial voltage, the target voltage, and the second auxiliary voltages, and to supply the selected voltage to the controller as the reference voltage.

### CROSS-REFERENCE TO RELATED APPLICATION

This application claims priority to and the benefit of Korean Patent Application No. 10-2014-0087515, filed on Jul. 11, 2014, in the Korean Intellectual Property Office, the contents of which are incorporated herein by reference in their entirety.

### BACKGROUND

1. Field

Aspects of embodiments of the present invention relate to a DC-DC converter and an organic light emitting display device having the same.

2. Description of the Related Art

Recently, there have been developed various types of flat panel displays having reduced weight and volume in comparison to cathode ray tubes. The various types of flat panel displays include a liquid crystal display, a field emission display, a plasma display panel, an organic light emitting display, and the like.

Among these flat panel displays, the organic light emitting display displays images using organic light emitting diodes that emit light through recombination of electrons and holes. The organic light emitting display has a fast response speed and displays a clear image.

The organic light emitting display includes a DC-DC converter configured to generate a voltage for driving the organic light emitting display by converting an external voltage.

As the organic light emitting display has been widely employed in mobile devices and the like having batteries, it is desirable to improve the efficiency of the DC-DC converter.

### SUMMARY

According to an embodiment of the present invention, a DC-DC converter includes: a converter configured to convert a voltage input to an input terminal into a first voltage, and to output the first voltage to an output terminal; a controller configured to receive a feedback voltage and a reference voltage, and to control the converter; a first auxiliary voltage generator configured to receive a first input voltage and a second input voltage, and to generate a plurality of first auxiliary voltages; a first selector configured to select an initial voltage and a target voltage from among the first auxiliary voltages; a second auxiliary voltage generator configured to receive the initial voltage and the target voltage, and to generate a plurality of second auxiliary voltages; and a second selector configured to select any one voltage from the initial voltage, the target voltage, and the second auxiliary voltages, and to supply the selected voltage to the controller as the reference voltage.

Each of the second auxiliary voltages may have a level between the initial voltage and the target voltage.

The second selector may be configured to select in an order of the initial voltage, at least one of the secondary auxiliary voltages, and the target voltage, and to output the selected voltages in the order as the reference voltages.

The first auxiliary voltage generator may include a plurality of first voltage dividing resistors coupled between a first auxiliary input terminal to which the first input voltage is input and a second auxiliary input terminal to which the second input voltage is input.

The second auxiliary voltage generator may include a plurality of second voltage dividing resistors coupled between a third auxiliary input terminal to which the target voltage is input and a fourth auxiliary input terminal to which the initial voltage is input.

The second auxiliary voltage generator may further include a control switch coupled between the third auxiliary input terminal and the fourth auxiliary input terminal.

The controller may include: an error amplifier configured to supply, to a pulse width modulation (PWM) control circuit, an error signal corresponding to a difference between the feedback voltage and the reference voltage; and the PWM control circuit may be configured to change the first voltage by controlling the converter corresponding to the error signal.

The DC-DC converter may further include a feedback voltage generator configured to generate the feedback voltage by dividing the first voltage, and to supply the generated feedback voltage to the controller.

The converter may include: a first switch coupled between the input terminal and a common node; a second switch coupled between the common node and the output terminal; and an inductor coupled between the common node and a ground.

According to another embodiment of the present invention, an organic light emitting display includes: a plurality of pixels coupled to scan lines and data lines; and a DC-DC converter configured to supply a first voltage to the pixels, the DC-DC converter including: a converter configured to convert a voltage input to an input terminal into a first voltage, and to output the first voltage to an output terminal; a controller configured to receive a feedback voltage and a reference voltage, and to control the converter; a first auxiliary voltage generator configured to receive a first input voltage and a second input voltage, and to generate a plurality of first auxiliary voltages; a first selector configured to select an initial voltage and a target voltage from among the first auxiliary voltages; a second auxiliary voltage generator configured to receive the initial voltage and the target voltage, and to generate a plurality of second auxiliary voltages; and a second selector configured to select any one voltage from the initial voltage, the target voltage, and the second auxiliary voltages, and to supply the selected voltage to the controller as the reference voltage.

Each of the second auxiliary voltages may have a level between the initial voltage and the target voltage.

The second selector may be configured to select in an order of the initial voltage, at least one of the second auxiliary voltages, and the target voltage, and to output the selected voltages in the order as the reference voltages.

The first auxiliary voltage generator may include a plurality of first voltage dividing resistors coupled between a first auxiliary input terminal to which the first input voltage is input and a second auxiliary input terminal to which the second input voltage is input.

The second auxiliary voltage generator may include a plurality of second voltage dividing resistors coupled between a third auxiliary input terminal to which the target voltage is input and a fourth auxiliary input terminal to which the initial voltage is input.

The second auxiliary voltage generator may further include a control switch coupled between the third auxiliary input terminal and the fourth auxiliary input terminal.

The controller may include: an error amplifier configured to supply, to a pulse width modulation (PWM) control circuit, an error signal corresponding to a difference between the feedback voltage and the reference voltage; and the PWM control circuit may be configured to change the first voltage by controlling the converter corresponding to the error signal.

The organic light emitting display may further include a feedback voltage generator configured to generate the feedback voltage by dividing the first voltage, and to supply the generated feedback voltage to the controller.

The converter may include: a first switch coupled between the input terminal and a common node; a second switch coupled between the common node and the output terminal; and an inductor coupled between the common node and a ground.

The organic light emitting display may further include: a scan driver configured to supply scan signals through the scan lines; and a data driver configured to supply data signals through the data lines.

### BRIEF DESCRIPTION OF THE DRAWINGS

Example embodiments will now be described more fully hereinafter with reference to the accompanying drawings. However, aspects of the present invention may be embodied in different forms and should not be construed as limited to the embodiments set forth herein. Rather, these embodiments are provided so that this disclosure will be thorough and complete, and will fully convey the spirit and scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Further, it will be understood that when an element or layer is referred to as being “on”, “connected to”, or “coupled to” another element or layer, it can be directly on, connected to, or coupled to the other element or layer, or one or more intervening elements or layers may be present. When an element or layer is referred to as being “directly on,” “directly connected to”, or “directly coupled to” another element or layer, there are no intervening elements or layers present. Like reference numerals refer to like elements throughout.

FIG. 1 illustrates an organic light emitting display according to an embodiment.

FIG. 2 illustrates a pixel according to an embodiment as shown in FIG. 1.

FIG. 3 illustrates a DC-DC converter according to an embodiment.

FIG. 4 illustrates in further detail a controller according to an embodiment.

FIG. 5 illustrates a first auxiliary voltage generation unit, a first selection unit, a second auxiliary voltage generation unit and a second selection unit according to an embodiment.

FIG. 6 illustrates change to a reference voltage according to an embodiment.

FIG. 7 illustrates a second auxiliary voltage generation unit according to another embodiment.

### DETAILED DESCRIPTION

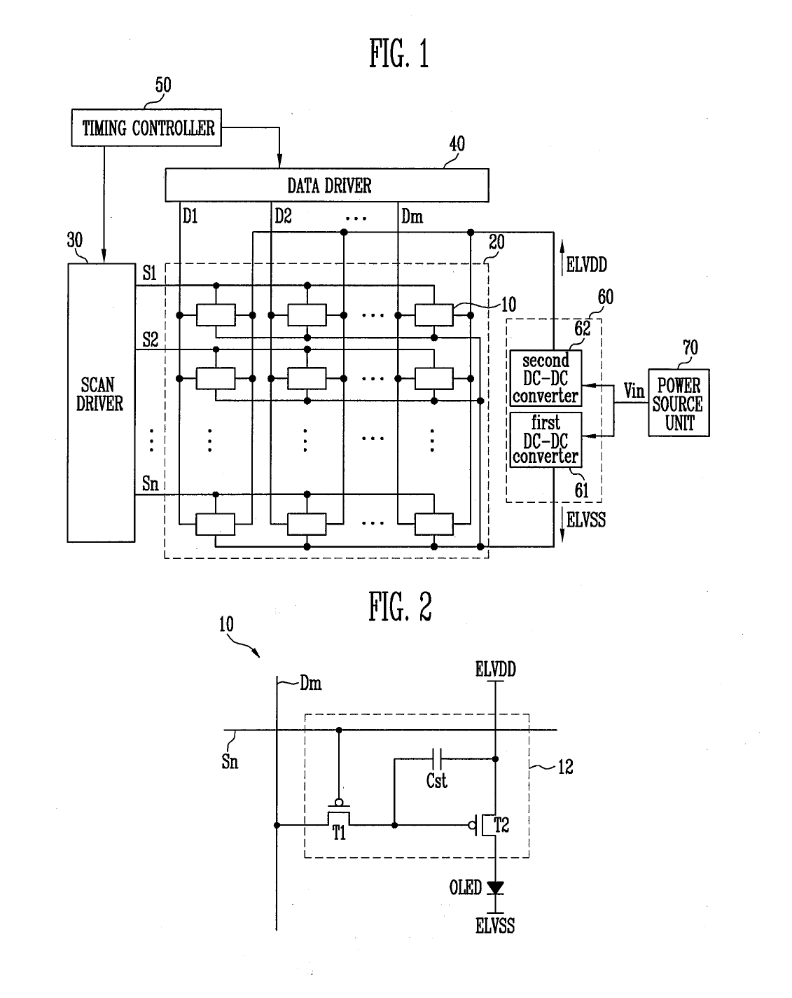

FIG. 1 illustrates an organic light emitting display according to an embodiment.

Referring to FIG. 1, the organic light emitting display may include a display unit 20 having a plurality of pixels 10 coupled to scan lines S1 to Sn and data lines D1 to Dm, a scan driver 30 configured to supply scan signals to the pixels 10 through the scan lines S1 to Sn, a data driver 40 configured to supply data signals to the pixels 10 through the data lines D1 to Dm, and a power supply unit 60 configured to supply a first voltage ELVSS and a second voltage ELVDD to each pixel 10. The organic light emitting display may further include a timing controller 50 configured to control the scan driver 30 and the data driver 40.

Each pixel 10 receiving the first voltage ELVSS and the second voltage ELVDD from the power supply unit 60, may generate light corresponding to the data signal according to a current flowing from the second voltage ELVDD to the first voltage ELVSS via an organic light emitting diode.

The scan driver 30 may generate scan signals under control of the timing controller 50, and supply the generated scan signals to the scan lines S1 to Sn.

The data driver 40 may generate data signals under the control of the timing controller 50, and supply the generated data signals to the data lines D1 to Dm.

When the scan signal is supplied to a specific scan line, the pixels 10 coupled to the specific scan line may receive a data signal supplied from the data lines D1 to Dm. Accordingly, each pixel 10 may emit light having a brightness corresponding to the supplied data signal.

The power supply unit 60 may include a first DC-DC converter 61 configured to supply the first voltage ELVSS to the pixels 10 and a second DC-DC converter 62 configured to supply the second voltage ELVDD to the pixels 10.

The first DC-DC converter 61 may receive a voltage Vin from a power source unit 70, and may generate the first voltage ELVSS supplied to each pixel 10 by converting the voltage Vin.

The second DC-DC converter 62 may receive the voltage Vin from the power source unit 70, and may generate the second voltage ELVDD supplied to each pixel 10 by converting the voltage Vin.

The first voltage ELVSS may be set to a negative voltage, and the second voltage ELVDD may be set to a positive voltage.

The power source unit 70 may include a battery configured to provide direct current power, or may include a rectifier unit configured to convert alternating current power into direct current power. However, the power source unit 70 is not limited thereto.

FIG. 2 illustrates a pixel according to an embodiment as shown in FIG. 1. For convenience of illustration, a pixel coupled to an n-th scan line Sn and an m-th data line Dm is shown in FIG. 2.

Referring to FIG. 2, each pixel 10 may include an organic light emitting diode OLED, and a pixel circuit 12 coupled to the data line Dm and the scan line Sn to control the organic light emitting diode OLED.

An anode electrode of the organic light emitting diode OLED may be coupled to the pixel circuit 12, and a cathode electrode of the organic light emitting diode OLED may be coupled to the first voltage ELVSS.

The organic light emitting diode OLED may generate light with a luminance (e.g., a predetermined luminance) corresponding to current supplied from the pixel circuit 12.

The pixel circuit 12 may control the amount of current supplied to the organic light emitting diode OLED, corresponding to a data signal supplied to the data line Dm when a scan signal is supplied to the scan line Sn. The pixel circuit 12 may include a second pixel transistor T2 coupled between the second voltage ELVDD and the organic light emitting diode OLED, a first pixel transistor T1 coupled between the second pixel transistor T2, the data line Dm, and the scan line Sn, and a storage capacitor Cst coupled between a gate electrode and a first electrode of the second pixel transistor T2.

A gate electrode of the first pixel transistor T1 may be coupled to the scan line Sn, and a first electrode of the first pixel transistor T1 may be coupled to the data line Dm.

A second electrode of the first pixel transistor T1 may be coupled to one terminal of the storage capacitor Cst.

Here, the first electrode of the transistors T1 and T2 may be set as a suitable one of source and drain electrodes, and the second electrode of the transistors T1 and T2 may be set as an electrode different from the first electrode. For example, if the first electrode is set as the source electrode, the second electrode may be set as the drain electrode.

The first pixel transistor T1 coupled to the scan line Sn and the data line Dm is turned on when the scan signal is supplied from the scan line Sn. When the first pixel transistor T1 is turned on, the data signal is supplied from the data line Dm to the storage capacitor Cst. In this case, the storage capacitor Cst may charge a voltage corresponding to the data signal.

The gate electrode of the second pixel transistor T2 may be coupled to the one terminal of the storage capacitor Cst, and the first electrode of the second pixel transistor T2 may be coupled to the other terminal of the storage capacitor Cst and to the first voltage ELVDD. A second electrode of the second pixel transistor T2 may be coupled to the anode electrode of the organic light emitting diode OLED.

The second pixel transistor T2 may control the amount of current flowing from the second voltage ELVDD to the first voltage ELVSS via the organic light emitting diode OLED, corresponding to the voltage stored in the storage capacitor Cst.

In this case, the organic light emitting diode OLED may generate light corresponding to the amount of current supplied from the second pixel transistor T2.

The pixel structure illustrated in FIG. 2 is merely an example embodiment of the present invention, and therefore, the pixel 10 of the present invention is not limited to the pixel structure shown in FIG. 2. For example, the pixel circuit 12 has a circuit structure capable of supplying current to the organic light emitting diode OLED, and may include any suitable structure known in the art.

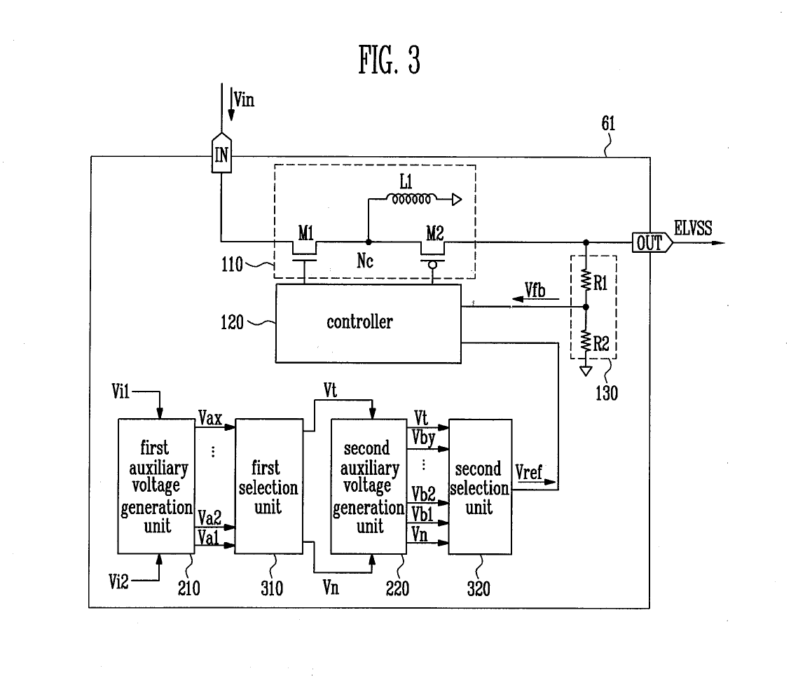

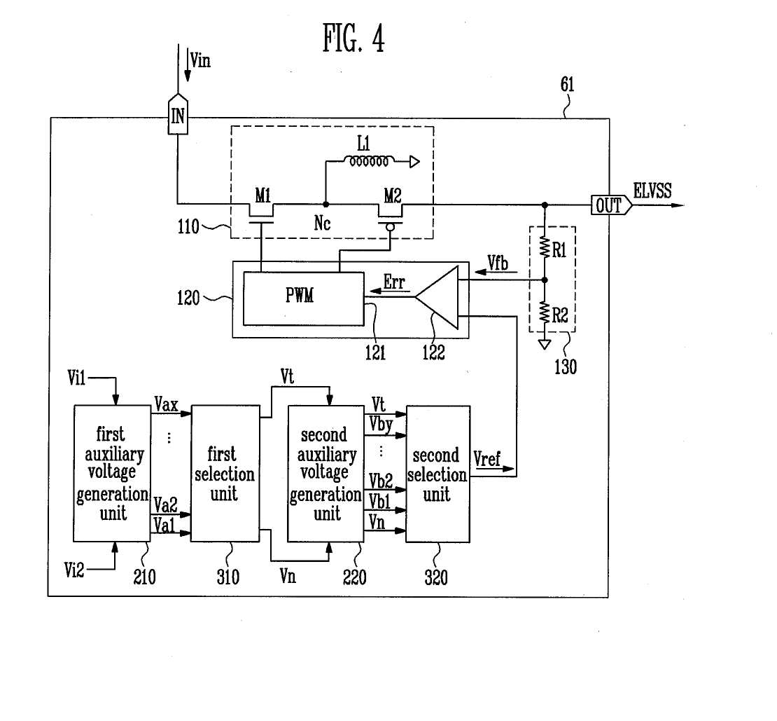

FIG. 3 illustrates a DC-DC converter according to an embodiment.

Referring to FIG. 3, the DC-DC converter 61 according to the described embodiment may include a conversion unit 110 (e.g., a converter), a controller 120, a first auxiliary voltage generation unit 210 (e.g., a first auxiliary voltage generator), a first selection unit 310 (e.g., a first selector), a second auxiliary voltage generation unit 220 (e.g., a second auxiliary voltage generator), and a second selection unit 320 (e.g., a second selector).

The conversion unit 110 may convert a voltage Vin input to an input terminal IN into the first voltage ELVSS, and may output the first voltage ELVSS to an output terminal OUT.

The voltage Vin input to the input terminal IN may be supplied from the power source unit 70. Furthermore, the first voltage ELVSS output through the output terminal OUT may be supplied to each pixel 10.

For example, the conversion unit 110 may include a first switching element M1 (e.g., a first switch), a second switching element M2 (e.g., a second switch), and an inductor L1.

The first switching element M1 may be coupled between the input terminal IN and a common node Nc.

The second switching element M2 may be coupled between the common node Nc and the output terminal OUT.

The inductor L1 may be coupled between the common node Nc and a ground.

The first switching element M1 and the second switching element M2 may be controlled (e.g., turned on and off) by the controller 120.

For example, the first switching element M1 and the second switching element M2 may be alternately (e.g., sequentially) turned on.

Also, the first switching element M1 and the second switching element M2 may each include a transistor.

In addition, the first switching element M1 and the second switching element M2 may include a transistor having different conductive types for convenience of control. For example, if the first switching element M1 includes an N-type transistor, the second switching element M2 may include a P-type transistor.

However, the structure of the conversion unit 110 described above is merely an example embodiment, and therefore, the conversion unit 110 is not limited to the conversion unit structured described above. For example, the conversion unit 110 may have a different structure capable of converting the voltage Vin input from the power source unit 70 into the first voltage ELVSS, and may include any suitable structure known in the art.

The controller 120 may receive a feedback voltage Vfb and a reference voltage Vref, and may control the conversion unit 110 according to the feedback voltage Vfb and the reference voltage Vref.

For example, the controller 120 may control the on-off operations of the first switching element M1 and the second switching element M2 included in the conversion unit 110, so that the voltage being input Vin may be converted into the first voltage ELVSS having a desired voltage level.

The DC-DC converter 61 according to an embodiment may further include a feedback voltage generation unit 130 configured to supply the feedback voltage Vfb to the controller 120.

That is, the feedback voltage generation unit 130 may generate a feedback voltage Vfb by dividing the first voltage ELVSS and supply the generated feedback voltage Vfb to the controller 120.

The feedback voltage generation unit 130 may include a plurality of resistors R1 and R2 coupled to the output terminal OUT, to divide the first voltage ELVSS output to the output terminal OUT.

FIG. 3 shows two resistors R1 and R2, but the present invention is not limited thereto, and the number of resistors included in the feedback voltage generation unit 130 may vary.

The first auxiliary voltage generation unit 210 may receive a first input voltage Vi1 and a second input voltage Vi2, and may generate a plurality of first auxiliary voltages Va1, Va2, . . . and Vax.

For example, the first auxiliary voltage generation unit 210 may divide the first input voltage Vi1 and the second input voltage Vi2, and may generate the first auxiliary voltages Va1, Va2, . . . and Vax.

As a result, the first auxiliary voltages Va1, Va2 . . . and Vax may have voltage levels between the first input voltage Vi1 and the second input voltage Vi2.

For example, any one of the first input voltage Vi1 and the second input voltage Vi2, etc. may be set to a ground voltage.

The first selection unit 310 may receive the first auxiliary voltages Va1, Va2, . . . and Vax from the first auxiliary voltage generation unit 210, and the initial voltage Vn and the target voltage Vt may be selected from the first auxiliary voltages Va1, Va2, . . . and Vax.

The second auxiliary voltage generation unit 220 may receive the initial voltage Vn and the target voltage Vt from the first selection unit 310, and may generate a plurality of second auxiliary voltages Vb1, Vb2, . . . and Vby.

For example, the second auxiliary voltage generation unit 220 may divide the initial voltage Vn and the target voltage Vt, and may generate the second auxiliary voltages Vb1, Vb2, . . . and Vby.

Therefore, the second auxiliary voltages Vb1, Vb2, . . . and Vby may have voltage levels between the initial voltage Vn and the target voltage Vt.

The second selection unit 320 may select any one of the initial voltage Vn, the target voltage Vt and the second auxiliary voltages Vb1, Vb2, . . . and Vby as a reference voltage Vref, and may supply the selected reference voltage Vref to the controller 120.

To this end, the second selection unit 320 may receive the second auxiliary voltages Vb1, Vb2, . . . and Vby from the second auxiliary voltage generation unit 220.

The second selection unit 320 may receive the initial voltage Vn and the target voltage Vt from the second auxiliary voltage generation unit 220.

The second selection unit 320 may also receive the initial voltage Vn and the target voltage Vt from the first selection unit 310.

Depending on an operation of the second selection unit 320, the level of the reference voltage Vref supplied to the controller 120 may change.

The second selection unit 320 may sequentially select the initial voltage Vn, at least one of the second auxiliary voltages, and the target voltage Vt, to output as the reference voltage Vref.

For example, the second selection unit 320 may set the initial voltage Vn as the reference voltage Vref and set at least one of the second auxiliary voltages Vb1, Vb2, . . . , Vby as the reference voltage Vref. The second selection unit 320 may set the target voltage Vt as the reference voltage Vref.

FIG. 4 illustrates in further detail a controller according to an embodiment.

Referring to FIG. 4, the controller 120 according to an embodiment may include a pulse width modulation (PWM) control circuit 121 and an error amplifier 122.

The error amplifier 122 may receive the feedback voltage Vfb input from the feedback voltage generation unit 130, and may receive a reference voltage Vref from the second selection unit 320.

Furthermore, the error amplifier 122 may supply, to the PWM control circuit 121, an error signal Err corresponding to a difference between the feedback voltage Vfb and the reference voltage Vref.

The PWM control circuit 121 may control the conversion unit 110 corresponding to the error signal Err supplied from the error amplifier 122.

Depending on the control of the PWM control circuit 121, the first voltage ELVSS output from the conversion unit 110 may be changed.

For example, the PWM control circuit 121 may control a switching operation of the switching elements M1 and M2 included in the conversion unit 110 corresponding to the error signal Err.

That is, the PWM control circuit 121 may control the on-off operations of the first switching element M1 and the second switching element M2, so that the duty ratio of each switching element M1 or M2 can be controlled, thereby changing the level of the first voltage ELVSS.

For example, when the level of the reference voltage Vref is increased, the difference between the feedback voltage Vfb and the reference voltage Vref may be further decreased, which may be reported to the PWM control circuit 150 by the error signal Err of the error amplifier 122.

Therefore, the PWM control circuit 121 may control the conversion unit 110 to increase the first voltage ELVSS according to the error signal Err.

When the level of the reference voltage Vref is decreased, the difference between the feedback voltage Vfb and the reference voltage Vref may be further increased. This may be reported to the PWM control circuit 121 by the error signal Err of the error amplifier 122.

Thus, the PWM control circuit 121 may control the conversion unit 110 to decrease the first voltage ELVSS according to the error signal Err.

The reference voltage Vref may change according to an operation of the second selection unit 320. Accordingly, the level of the first voltage ELVSS may also change.

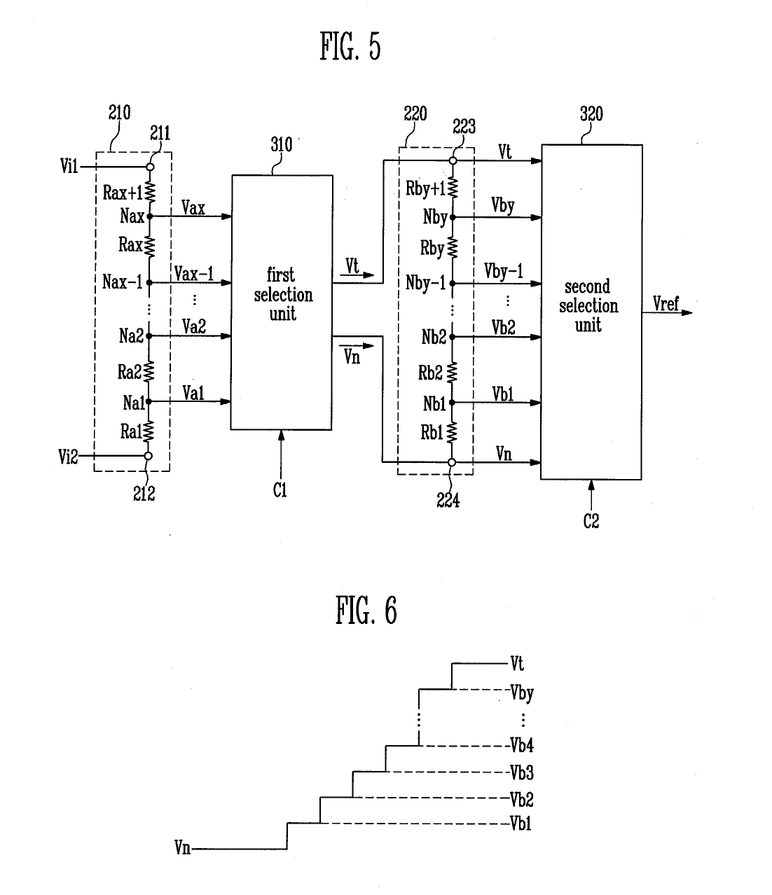

FIG. 5 illustrates a first auxiliary voltage generation unit, a first selection unit, a second auxiliary voltage generation unit and a second selection unit according to an embodiment.

Referring to FIG. 5, the first auxiliary voltage generation unit 210 according to an embodiment may include a plurality of first voltage dividing resistors Ra1, Ra2, . . . Rax, and Rax+1 coupled between a first auxiliary input terminal 211 and a second auxiliary input terminal 212.

The first input voltage Vi1 may be input to the first auxiliary input terminal 211, and the second input voltage Vi2 may be input to the second auxiliary input terminal 212.

Therefore, the first auxiliary voltages Va1, Va2, . . . and Vax may be respectively output through nodes Na1, Na2, . . . and Nax between the first voltage dividing resistors Ra1, Ra2, . . . Rax, Rax+1.

The first selection unit 310 may select two voltages from the first auxiliary voltages Va1, Va2, . . . and Vax as the initial voltage Vn and the target voltage Vt in response to a first selection control signal C1.

The second auxiliary voltage generation unit 220 according to an embodiment may include a plurality of second voltage dividing resistors Rb1, Rb2, . . . , Rby, and Rby+1 coupled between a third auxiliary input terminal 223 and a fourth auxiliary input terminal 224.

The target voltage Vt may be input to the third auxiliary input terminal 223, and the initial voltage Vn may be input to the fourth auxiliary input terminal 224.

Therefore, the second auxiliary voltages Vb1, Vb2, . . . and Vby may be respectively output through the nodes Nb1, Nb2, . . . Nby between the second voltage dividing resistors Rb1, Rb2, . . . Rby and Rby+1. The target voltage Vt and the initial voltage Vn may be respectively output through the third auxiliary input terminal 223 and the fourth auxiliary input terminal 224.

The second selection unit 320 may change the level of the reference voltage Vref in response to the second selection control signal C2 input from an external source.

For example, the first selection control signal C1 and a second selection control signal C2 may be supplied from a timing controller 50.

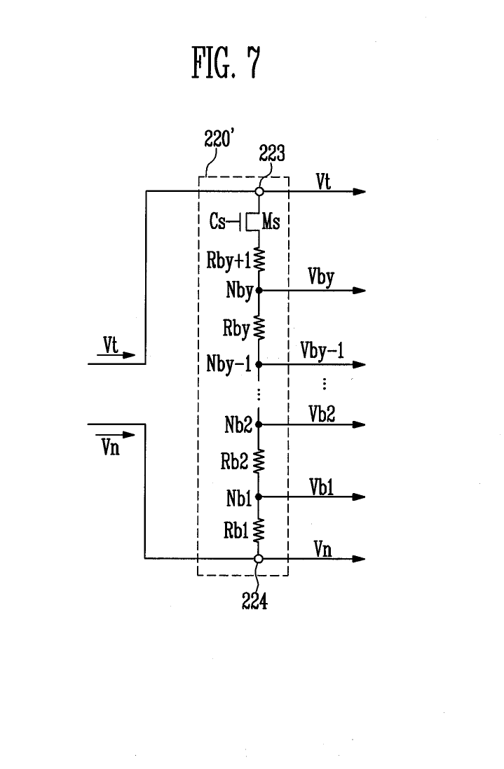

FIG. 6 illustrates change to a reference voltage according to an embodiment.

Referring to FIG. 6, an operation of a second selection unit 320 according to an embodiment will be described.

The second selection unit 320 may receive the initial voltage Vn, the target voltage Vt and the plurality of second auxiliary voltages Vb1, Vb2, . . . and Vby.

The second selection unit 320 may select and output the initial voltage Vn from a plurality of voltages that are input.

The second selection unit 320 may select at least one voltage from the second auxiliary voltages Vb1, Vb2, . . . and Vby and output the selected voltage.

For example, the second selection unit 320 may, as shown in FIG. 6, sequentially select and output a Vb1 auxiliary voltage, a Vb2 auxiliary voltage, a Vb3 auxiliary voltage, a Vb4 auxiliary voltage, . . . to a Vby auxiliary voltage.

Alternatively, the second selection unit 320 may sequentially select and output some of the second auxiliary voltages Vb1, Vb2, . . . and Vby.

Eventually, the second selection unit 320 may select the target voltage Vt from among the plurality of voltages that are input, and output the selected target voltage Vt.

Through the above-described process, the reference voltage Vref may change from the initial voltage Vn to the target voltage Vt.

Accordingly, in an embodiment, the reference voltage Vref may not change from the initial voltage Vn to the target voltage Vt immediately, but may change first to at least one second auxiliary voltage, thereby preventing rapid change in the first voltage ELVSS.

Therefore, display quality issues arising from rapid change in the first voltage ELVSS may be prevented or reduced in advance.

FIG. 7 illustrates a second auxiliary voltage generation unit according to another embodiment.

Referring to FIG. 7, the second auxiliary voltage generation unit 220 according to another embodiment may additionally include a control switching element Ms (e.g., control switch).

That is, the second auxiliary voltage generation unit 220′ according to another embodiment may include a plurality of second voltage dividing resistors Rb1, Rb2, . . . , Rby, and Rby+1 coupled between a third auxiliary input terminal 223 and a fourth auxiliary input terminal 224, and a control switching element Ms (e.g., control switch) for electrically coupling or blocking the third auxiliary input terminal 223 and the fourth auxiliary input terminal 224.

For example, the control switching element Ms may be coupled between the third auxiliary input terminal 223 and the second voltage dividing resistors Rb1, Rb2, . . . Rby, and Rby+1.

Alternatively, the control switching element Ms may be coupled between the fourth auxiliary input terminal 224 and the second voltage dividing resistors Rb1, Rb2, . . . Rby, and Rby+1.

Further, the control switching element Ms may be coupled between any two resistors from the second voltage dividing resistors Rb1, Rb2, . . . Rby, and Rby+1.

When it is not necessary or desirable to generate the second auxiliary voltages Vb1, Vb2, . . . and Vby (for example, when the reference voltage Vref is immediately changed from the initial voltage Vn to the target voltage Vt), unnecessary power consumption may be prevented or reduced by turning off the control switching element Ms.

That is, when the control switching element Ms is turned off, the second selection unit 320 may sequentially select and output the initial voltage Vn and the target voltage Vt.

The control switching element Ms may be turned on when it is necessary or desirable to generate the second auxiliary voltages Vb1, Vb2, . . . and Vby.

The on-off operations of the control switching element Ms may be controlled by a switching control signal Cs supplied from an external device.

The switching control signal Cs may be supplied from the timing controller 50.

For example, the control switching element Ms may include a transistor.

By way of summation and review, according to embodiments of the present invention, it may be possible to provide a DC-DC converter and an organic light emitting display including the same, in which a reference voltage is varied, thereby controlling the output voltage of the DC-DC converter.

Also, it may be possible to provide a DC-DC converter and an organic light emitting display including the same, in which rapid change in an output voltage may be prevented or reduced.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments, unless otherwise specifically indicated. Accordingly, it will be understood by those of skill in the art that various changes in form and details may be made without departing from the spirit and scope of the present invention as set forth in the following claims, and their equivalents.

What is claimed is:

1. A DC-DC converter, comprising: a converter configured to convert a voltage input to an input terminal into a first voltage, and to output the first voltage to an output terminal;
a controller configured to receive a feedback voltage and a reference voltage, and to control the converter;
a first auxiliary voltage generator configured to receive a first input voltage and a second input voltage, and to generate a plurality of first auxiliary voltages;
a first selector configured to select an initial voltage and a target voltage from among the first auxiliary voltages;
a second auxiliary voltage generator configured to receive the initial voltage and the target voltage, and to generate a plurality of second auxiliary voltages; and
a second selector configured to select any one voltage from the initial voltage, the target voltage, and the second auxiliary voltages, and to supply the selected voltage to the controller as the reference voltage.

2. The DC-DC converter of claim 1, wherein each of the second auxiliary voltages has a level between the initial voltage and the target voltage.

3. The DC-DC converter of claim 2, wherein the second selector is configured to select in an order of the initial voltage, at least one of the secondary auxiliary voltages, and the target voltage, and to output the selected voltages in the order as the reference voltages.

4. The DC-DC converter of claim 2, wherein the first auxiliary voltage generator comprises a plurality of first voltage dividing resistors coupled between a first auxiliary input terminal to which the first input voltage is input and a second auxiliary input terminal to which the second input voltage is input.

5. The DC-DC converter of claim 1, wherein the second auxiliary voltage generator comprises a plurality of second voltage dividing resistors coupled between a third auxiliary input terminal to which the target voltage is input and a fourth auxiliary input terminal to which the initial voltage is input.

6. The DC-DC converter of claim 5, wherein the second auxiliary voltage generator further comprises a control switch coupled between the third auxiliary input terminal and the fourth auxiliary input terminal.

7. The DC-DC converter of claim 1, wherein the controller comprises:
an error amplifier configured to supply, to a pulse width modulation (PWM) control circuit, an error signal corresponding to a difference between the feedback voltage and the reference voltage; and
the PWM control circuit is configured to change the first voltage by controlling the converter corresponding to the error signal.

8. The DC-DC converter of claim 1, further comprising a feedback voltage generator configured to generate the feedback voltage by dividing the first voltage, and to supply the generated feedback voltage to the controller.

9. The DC-DC converter of claim 1, wherein the converter comprises:
a first switch coupled between the input terminal and a common node;
a second switch coupled between the common node and the output terminal; and
an inductor coupled between the common node and a ground.

10. An organic light emitting display, comprising: a plurality of pixels coupled to scan lines and data lines; and
a DC-DC converter configured to supply a first voltage to the pixels, the DC-DC converter comprising: a converter configured to convert a voltage input to an input terminal into a first voltage, and to output the first voltage to an output terminal;
a controller configured to receive a feedback voltage and a reference voltage, and to control the converter;
a first auxiliary voltage generator configured to receive a first input voltage and a second input voltage, and to generate a plurality of first auxiliary voltages;
a first selector configured to select an initial voltage and a target voltage from among the first auxiliary voltages;
a second auxiliary voltage generator configured to receive the initial voltage and the target voltage, and to generate a plurality of second auxiliary voltages; and
a second selector configured to select any one voltage from the initial voltage, the target voltage, and the second auxiliary voltages, and to supply the selected voltage to the controller as the reference voltage.

11. The organic light emitting display of claim 10, wherein each of the second auxiliary voltages has a level between the initial voltage and the target voltage.

12. The organic light emitting display of claim 11, wherein the second selector is configured to select in an order of the initial voltage, at least one of the second auxiliary voltages, and the target voltage, and to output the selected voltages in the order as the reference voltages.

13. The organic light emitting display of claim 10, wherein the first auxiliary voltage generator comprises a plurality of first voltage dividing resistors coupled between a first auxiliary input terminal to which the first input voltage is input and a second auxiliary input terminal to which the second input voltage is input.

14. The organic light emitting display of claim 10, wherein the second auxiliary voltage generator comprises a plurality of second voltage dividing resistors coupled between a third auxiliary input terminal to which the target voltage is input and a fourth auxiliary input terminal to which the initial voltage is input.

15. The organic light emitting display of claim 14, wherein the second auxiliary voltage generator further comprises a control switch coupled between the third auxiliary input terminal and the fourth auxiliary input terminal.

16. The organic light emitting display of claim 10, wherein the controller comprises:
an error amplifier configured to supply, to a pulse width modulation (PWM) control circuit, an error signal corresponding to a difference between the feedback voltage and the reference voltage; and
the PWM control circuit is configured to change the first voltage by controlling the converter corresponding to the error signal.

17. The organic light emitting display of claim 10, further comprising a feedback voltage generator configured to generate the feedback voltage by dividing the first voltage, and to supply the generated feedback voltage to the controller.

18. The organic light emitting display of claim 10, wherein the converter comprises:
a first switch coupled between the input terminal and a common node;
a second switch coupled between the common node and the output terminal; and
an inductor coupled between the common node and a ground.

19. The organic light emitting display of claim 10, further comprising:
a scan driver configured to supply scan signals through the scan lines; and
a data driver configured to supply data signals through the data lines.
